(19) United States
(12) Patent Application Publication
(10) Pub. No.: US 2019/0122585 A1
(43) Pub. Date: Apr. 25, 2019

(54) NUCLEAR-PLANT OPERATION TRAINING SIMULATOR

(71) Applicant: MITSUBISHI ELECTRIC CORPORATION, Chiyoda-ku, Tokyo (JP)

(72) Inventor: Kumiko Takegawa, Tokyo (JP)

(73) Assignee: MITSUBISHI ELECTRIC CORPORATION, Chiyoda-ku, Tokyo (JP)

(21) Appl. No.: 16/083,292

(22) PCT Filed: Jul. 11, 2016
(86) PCT No.: PCT/JP2016/070369

§ 371 Date: Sep. 7, 2018

(51) Int. Cl. G09B 25/02; G09B 19/00; G09B 9/00

(52) U.S. Cl. CPC G09B 25/02; G09B 9/00; G09B 19/00

(57) ABSTRACT

A floor-map display image that displays a floor-map image for an instrumentation panel room and the like in a nuclear plant, a hardware apparatus display image, and a maintenance tool display image are displayed in an multi-window manner on a display apparatus so that a hardware apparatus to be maintained and a maintenance tool are collated with each other in a floor map.

### TECHNICAL FIELD

The present invention relates to an operation training simulator that makes it possible to perform operation training for a nuclear plant on the screen of a display apparatus and more particularly to a screen display of the display apparatus.

### BACKGROUND ART

As is well known, a nuclear-plant maintenance man ascertains an alarm sounded in a central control room, and moves to an instrumentation panel room where hardware apparatuses such as a plant controller and a computer are installed, in accordance with the contents of the alarm; then, by use of a tool having a maintenance screen connected through a network with the hardware apparatuses, the maintenance man ascertains the conditions of the hardware apparatuses, based on the screen displaying the conditions of the hardware apparatuses, so as to determine the contents of the maintenance and then implements maintenance operation of the hardware apparatuses or maintenance operation of software items such as logics installed in the hardware apparatuses and computer applications.

Thus, a maintenance man of a nuclear plant is required to undergo an operation training for implementing maintenance operation of hardware apparatuses or maintenance operation of software items installed in the hardware apparatuses. In consideration of the importance of technology succession of the plant maintenance operation, there has been increasing the importance of a maintenance-man operation training for maintenance operation, in which the sensation of being at live events is created.

With regard to the operation training for a nuclear-plant maintenance man, by use of an operation training simulator, simulating a central control room, that is equipped with a full-scale controller panel and a full-scale computer panel, there is implemented an operation training for maintenance operation such as exchanging cards including necessary information items. However, in many cases, in terms of securing a space, it is difficult to secure, in operation training facilities of the nuclear plant, a space where in addition to a real controller panel and a real computer panel, the operation training simulator, for implementing an operation training, that simulates the central control room is installed. Accordingly, in recent years, there has been a tendency that by use a desk-top-type operation training simulator that can relatively readily be introduced, an operation training for a nuclear-plant maintenance man is realized.

In general, a desk-top-type operation training simulator includes two or more personal computers (referred to as PCs, hereinafter) and two or more display apparatuses in accordance with the number of hardware apparatuses such as controllers and computers installed in a real instrumentation panel room and the number of maintenance tools; however, in recent years, there has been a tendency that in terms of reducing the cost, the number of PCs and display apparatuses in a desk-top-type operation training simulator is decreased; thus, in some cases, instead of utilizing two or more display apparatuses, a single display apparatus having a multi-window function is adopted.

For example, in a conventional nuclear-plant operation training simulator disclosed in Patent Document 1, through a multi-window display program, two or more training-purpose monitoring windows for displaying monitoring operation images that correspond to two or more real monitors of a real operation console and are equivalent to display monitoring operation images of corresponding real monitors are displayed on the common display screen of a single display apparatus; a window-category type is displayed at the end portion of each of the two or more displayed training-purpose monitoring windows. With regard to each of the two or more displayed training-purpose monitoring windows, the display position thereof can freely be changed in accordance with the taste of a maintenance man.

In the conventional nuclear-plant operation training simulator disclosed in Patent Document 1, The two or more operation-training-purpose monitoring operation images corresponding to respective operation images displayed on the two or more monitors of the real operation console of a plant are displayed on the display screen of a common display apparatus; thus, the cost can be reduced.

### PRIOR ART REFERENCE

### Patent Document

[Patent Document 1] Japanese Patent Application Laid-Open No. 2014-77896

### DISCLOSURE OF THE INVENTION

### Problems to be Solved by the Invention

In the conventional nuclear-plant operation training simulator disclosed in foregoing Patent Document 1, multi-window control of monitoring operation images is utilized; thus, in the case where a maintenance training function, which has been required in recent years, for hardware apparatuses such as a controller and a computer and maintenance tools is required, it is necessary that the configuration of the hardware apparatuses are simulated and displayed and that only one maintenance tool image is displayed on a single display apparatus; therefore, when two or more maintenance tool images need to be displayed, it is required that an image that has been displayed is once closed and that the screen is restarted so that a necessary image is displayed; thus, there has been a problem, for example, that an unnecessary labor hour and time are required.

The present invention has been implemented in order to solve the foregoing problems in a conventional nuclear-plant operation training simulator; the objective thereof is to provide an operation training simulator that does not require unnecessary labor and time and that makes it possible to further reduce the cost and to readily perform the operation.

### Means for Solving the Problems

A nuclear-plant operation training simulator according to the present invention makes it possible to perform nuclear-plant operation training on a screen of a display apparatus; the nuclear-plant operation training simulator is characterized

in that the display apparatus can display in a multi-window manner at least one of a floor-map display window that displays a floor-map image corresponding to a floor on which a hardware apparatus for controlling the nuclear plant and a maintenance tool for maintaining the hardware apparatus are arranged, a window that displays a hardware apparatus image corresponding to the hardware apparatus, and a window that displays a maintenance tool image corresponding to the maintenance tool,

in that the window that displays the hardware apparatus image is displayed on the display apparatus when the hardware apparatus that is a subject of maintenance is selected in the floor-map image,

in that the window that displays the maintenance tool image is displayed on the display apparatus when the maintenance tool to be utilized for the maintenance is selected in the floor-map image, and

in that at least one of training for performing operation control of the nuclear plant and training for performing maintenance of the hardware apparatus can be implemented by use of at least one of the window, displayed on the display apparatus, that displays a hardware apparatus image corresponding to the hardware apparatus and the window that displays a maintenance tool image corresponding to the maintenance tool.

Advantage of the Invention

In a nuclear-plant operation training simulator according to the present invention, the display apparatus can display in a multi-window manner at least one of a floor-map display window that displays a floor-map image corresponding to a floor on which a hardware apparatus for controlling the nuclear plant and a maintenance tool for maintaining the hardware apparatus are arranged, a window that displays a hardware apparatus image corresponding to the hardware apparatus, and a window that displays a maintenance tool image corresponding to the maintenance tool; the window that displays the hardware apparatus image is displayed on the display apparatus when the hardware apparatus that is a subject of maintenance is selected in the floor-map image; the window that displays the maintenance tool image is displayed on the display apparatus when the maintenance tool to be utilized for the maintenance is selected in the floor-map image; at least one of training for performing operation control of the nuclear plant and training for performing maintenance of the hardware apparatus can be implemented by use of at least one of the window, displayed on the display apparatus, that displays a hardware apparatus image corresponding to the hardware apparatus and the window that displays a maintenance tool image corresponding to the maintenance tool. As a result, there can be obtained an operation training simulator that does not require unnecessary labor and time and that makes it possible to further reduce the cost and to readily perform the operation.

### BRIEF DESCRIPTION OF THE DRAWINGS

FIG. 1 is an explanatory view illustrating an example of display on a display apparatus in an operation training simulator according to Embodiment 1 of the present invention;

FIG. 2 is a functional configuration view illustrating the functional relationship between a floor-map display window and two or more operation training windows to be displayed in a multi-window manner, in the operation training simulator according to Embodiment 1 of the present invention;

FIG. 3 is a flowchart representing the procedure for blinking-displaying a hardware apparatus and a maintenance tool selected on the floor map, in the operation training simulator according to Embodiment 1 of the present invention;

FIG. 4 is a flowchart representing the procedure for displaying, on top of the other windows, a multi-window in which related information on selected equipment is displayed in the operation training simulator according to Embodiment 1 of the present invention;

FIG. 5 is a functional configuration diagram representing the way of associating a floor map with selection of an operation training window in an operation training simulator according to Embodiment 1 of the present invention;

FIG. 6 is a flowchart representing the procedure of image-display operation in the operation training simulator according to Embodiment 1 of the present invention;

FIG. 7 is a functional configuration diagram representing a multi-window alignment display function in an operation training simulator according to Embodiment 2 of the present invention;

FIG. 8 is a functional configuration diagram representing a multi-window all closure function in an operation training simulator according to Embodiment 3 of the present invention; and

FIG. 9 is a functional configuration diagram representing the relationship between multi-window image display control and an operation training function, a maintenance training function, and the like in an operation training simulator according to Embodiment 4 of the present invention.

### BEST MODE FOR CARRYING OUT THE INVENTION

### Embodiment 1

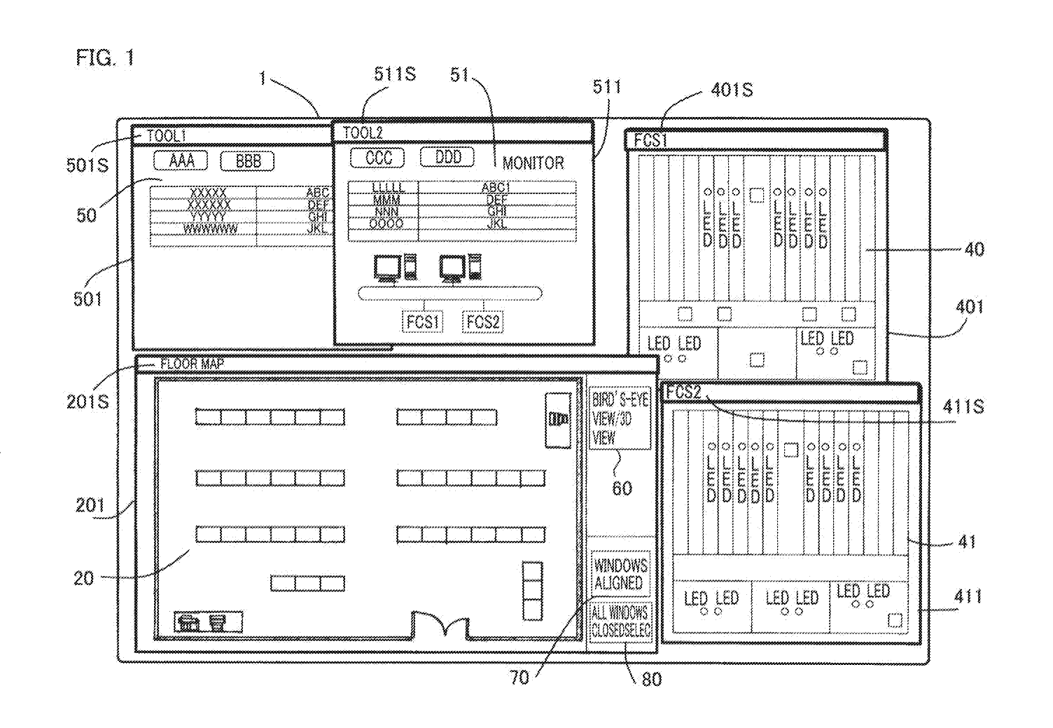

Hereinafter, an operation training simulator according to Embodiment 1 of the present invention will be explained based on the drawings. FIG. 1 is an explanatory view illustrating an example of display on a display apparatus in an operation training simulator according to Embodiment 1 of the present invention; FIG. 1 illustrates an example of a nuclear plant. In FIG. 1, a display apparatus 1 of the operation training simulator can simultaneously display two or more windows in accordance with a request of a maintenance man, by use of a multi-window display program.

In other words, specifically, on the display apparatus 1 illustrated in FIG. 1, there are simultaneously displayed a floor-map display window 201 that displays a floor-map image 20 of an instrumentation panel room of the nuclear plant, a first operation training window 401 that displays a hardware apparatus image 40 for representing the configuration of hardware apparatuses such as a controller and a computer installed in the instrumentation panel room of the nuclear plant, a second operation training window 411 that displays a hardware apparatus image 41 for representing the configuration of hardware apparatuses, such as a controller and a computer, that are different from the hardware apparatuses displayed in the first operation training window 401, a third operation training window 501 that displays a maintenance tool image 50 for representing a maintenance tool, and a fourth operation training window 511 that displays a maintenance tool image 51 that is different from the maintenance tool image displayed in the third operation training window.

The floor-map image 20 displayed in the floor-map display window 201 represents an indoor layout of, for example, the instrumentation panel room where hardware apparatuses such as a controller and a computer of a real nuclear plant are installed; the floor-map image 20 makes it possible to localize the installation positions of the hardware apparatuses such as the controller and the computer and the maintenance tool, in accordance with a request of the maintenance man. That is to say, when the maintenance man selects in a touching manner or clicks through a mouse, the position of an arbitrary hardware apparatus among the hardware apparatuses such as the controller and the computer in a floor map 20, for example, the positions of arbitrary two hardware apparatuses, there are displayed the first operation training window 401 that displays the hardware apparatus image 40 for representing the configuration of the hardware apparatuses such as the controller and the computer installed at the foregoing positions and the second operation training window 411 that displays the hardware apparatus image 41 that is different from the hardware apparatus image 40.

Similarly, when the maintenance man selects in a touching manner or clicks through a mouse, the position of an arbitrary maintenance tool among the maintenance tools represented in the floor map 20, for example, the positions of arbitrary two maintenance tools, there are displayed the third operation training window 501 that displays the maintenance tool image 50 for representing the maintenance tools installed at the foregoing positions and the fourth operation training window 511 that displays the maintenance tool image 51 that is different from the maintenance tool image 50.

[FLOOR MAP], as identification information 201S for indication of a display of the floor-map image, is displayed in the top-end zone of the floor-map display window 201 that represents the floor-map image 20. Respective abbreviations and apparatus names are provided to hardware apparatuses such as a controller and a computer and maintenance tools in a real nuclear plant; thus, the abbreviations and apparatus names are displayed, as identification information pieces in the respective top-end zones of corresponding operation training windows. In other words, [FCS1], as identification information 401S, is displayed in the top-end zone of the first operation training window 401 that displays the hardware apparatus image 40; [FCS2], as identification information 411S, is displayed in the top-end zone of the second operation training window 411 that displays the hardware apparatus image 41; [TOOL1], as identification information 501S, is displayed in the top-end zone of the third operation training window 501 that displays the maintenance tool image 50; [TOOL2], as identification information 511S, is displayed in the top-end zone of the fourth operation training window 511 that displays the maintenance tool image 51.

A switching button 60 for performing selective switching of floor-map display modes between a bird's eye view and a 3D view is disposed in the floor-map display window 201 that displays the floor-map image 20; press or click of the switching button 60 makes it possible to change the display mode of the floor-map image 20 into the bird's eye view or the 3D view.

In the floor-map display window 201, there is disposed a window alignment button 70 for displaying, in an aligned manner, for example, the first operation training window 401, the second operation training window 411, the third operation training window 501, and a fourth operation training window 511, which have been displayed in a multi-window manner, in arbitrary display order or in arbitrary display positions; press or click of the window alignment button 70 makes it possible to align the display order or the display positions of the foregoing multi-window-displayed operation training windows.

Furthermore, a window all closure button 80 is disposed in the floor-map display window 201; press or click of the all closure button 80 makes it possible to collectively close, for example, the first operation training window 401, the second operation training window 411, the third operation training window 501, and the fourth operation training window 511, which have been displayed in a multi-window manner.

Next, there will be explained below the operation of displaying the floor-map display window 201, the first operation training window 401, the second operation training window 411, the third operation training window 501, and the fourth operation training window 511 in a multi-window manner.

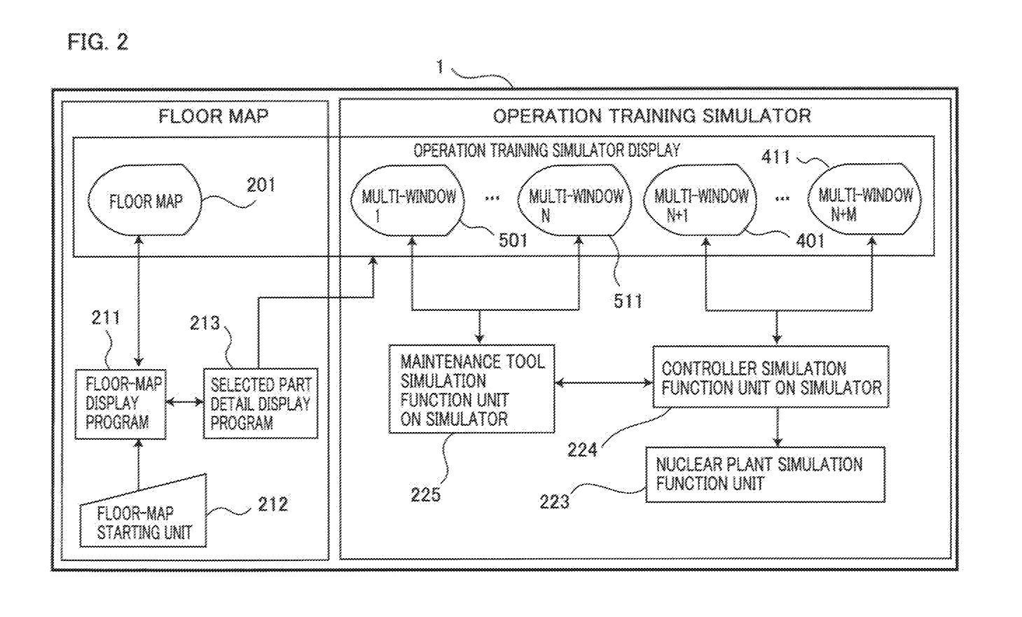

FIG. 2 is a functional configuration view illustrating the functional relationship between the floor-map display window and two or more operation training windows to be displayed in a multi-window manner, in the operation training simulator according to Embodiment 1 of the present invention. In FIG. 2, the floor-map display window is described as [floor map], and the two or more operation training windows to be displayed in a multi-window manner are each generalized and described as [multi-window 1], [multi-window N], [multi-window N+1], and [multi-window N+M]; it is assumed that [floor map] corresponds to the foregoing floor-map display window 201, [multi-window 1] corresponds to the foregoing third operation training window 501, [multi-window N] corresponds to the foregoing fourth operation training window 511, [multi-window N+1] corresponds to the foregoing first operation training window 401, and [multi-window N+M] corresponds to the foregoing second operation training window 411.

In FIGS. 1 and 2, at first, when the operation training simulator is initially started, only the floor-map display window 201 displaying the floor-map image 20 (refer to FIG. 1) is displayed on the display apparatus 1 of the operation training simulator. In this situation, when the maintenance man operates a floor-map starting unit 212 and hence there occurs, in the floor-map image 20, an event for selecting specific hardware apparatuses such as the controller and the computer and the maintenance tools, a selection-part detail display program 213 and a floor-map display program 211 determine to which facilities on the floor-map image 20 the hardware apparatuses and the maintenance tools selected by the maintenance man belong, performs processing of displaying detailed information on the selected hardware apparatuses in the first operation training window 401 and the second operation training window 411, and performs processing of displaying the selected maintenance tools in the third operation training window 501 and the fourth operation training window 511.

As a result, the first operation training window 401 and the second operation training window 411 that separately display the hardware apparatus images 40 and 41 corresponding to the selected hardware apparatuses and the third operation training window 501 and the fourth operation training window 511 that separately display the maintenance tool images 50 and 51 corresponding to the selected maintenance tools appear on the display apparatus 1 of the operation training simulator. In each of FIGS. 1 and 2, only the first operation training window 401, the second operation training window 411, the third operation training window 501, and the fourth operation training window 511 are displayed in a multi-window manner; however, it goes without saying that the number of operation training windows to be displayed in a multi-window manner corresponds to the selection in the floor-map image 20 by the maintenance man.

A controller simulation function unit 224 of the operation training simulator provides data pieces, calculated based on parameters from a nuclear-plant-model simulation function unit 223 that calculates the state of a real nuclear plant, to the first operation training window 401 that displays the hardware apparatus image 40, the second operation training window 411 that displays the hardware apparatus image 41, the third operation training window 501 that displays the maintenance tool image 50, and the fourth operation training window 511 that displays the maintenance tool image 51. Based on the data provided from the controller simulation function unit 224 of the operation training simulator, each of the first operation training window 401, the second operation training window 411, the third operation training window 501, and the fourth operation training window 511 simulates and displays the state of the real nuclear plant.

By means of a maintenance tool simulation function unit 225, the operator realizes the maintenance of the hardware apparatuses such as the controller and the computer on the first operation training window 401, the second operation training window 411, the third operation training window 501, and the fourth operation training window 511 that are displayed on the display apparatus 1 in a multi-window manner. The contents of the foregoing maintenance by the maintenance tool simulation function unit 225 are transferred to the nuclear-plant-model simulation function unit 223 and are reflected in the respective calculation values in the nuclear-plant-model simulation function unit 223 and the controller simulation function unit 224.

In addition to the images related to the maintenance, a training manual, a maintenance procedure, an operation procedure, and the like can be displayed at arbitrary positions in the images displayed in a multi-window manner, in accordance with the taste of the maintenance man.

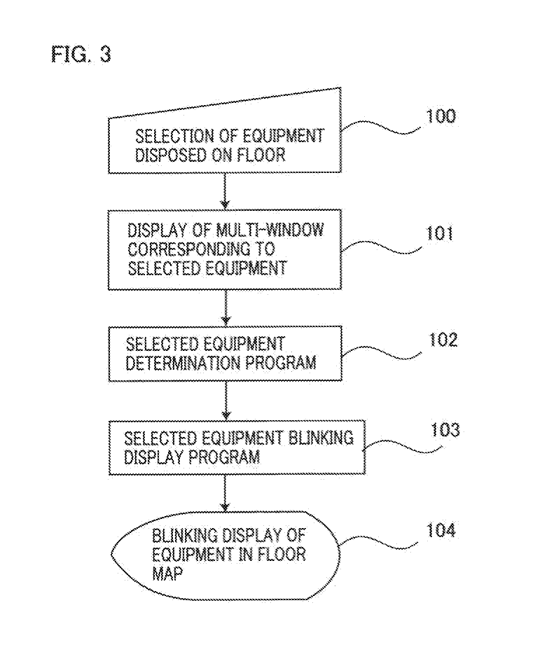

Next, there will be explained below the operation of intelligibly displaying, in the floor-map image 20 of the floor-map display window, the equipment such as the hardware apparatus and the maintenance tool that are operated by the maintenance man by use of the first operation training window 401, the second operation training window 411, the third operation training window 501, and the fourth operation training window 511. FIG. 3 is a flowchart representing the procedure for blinking-displaying a hardware apparatus and a maintenance tool selected on the floor map, in the operation training simulator according to Embodiment 1 of the present invention.

In FIG. 3, in the step 100, there occurs an event in which by means of the mouse or through touching, the maintenance man operates any one of the hardware apparatus images 40 and 41 for the controller and the computer and the maintenance tool images 50 and 51, by use of any one of the first operation training window 401 that displays the hardware apparatus image 40, the second operation training window 411 that displays the hardware apparatus image 41, the third operation training window 501 that displays the maintenance tool image 50, and the fourth operation training window 511 that displays the maintenance tool image 51.

Next, in the step 101, by use of a predetermined program for determining which operation training window the maintenance man is operating, it is determined which operation training window the maintenance man is operating. In the step 102, in the operation training window determined in the step 101, the equipment that has been selected by the maintenance man is determined, by means of a program for determining a hardware apparatus or a maintenance tool, as the equipment, that has been selected by the maintenance man. In the step 103, a program for blinking-displaying the selected equipment on the floor map is made to operate, so that in the step 104, the portion corresponding to the equipment operated by the maintenance man is blinking-displayed on the floor map.

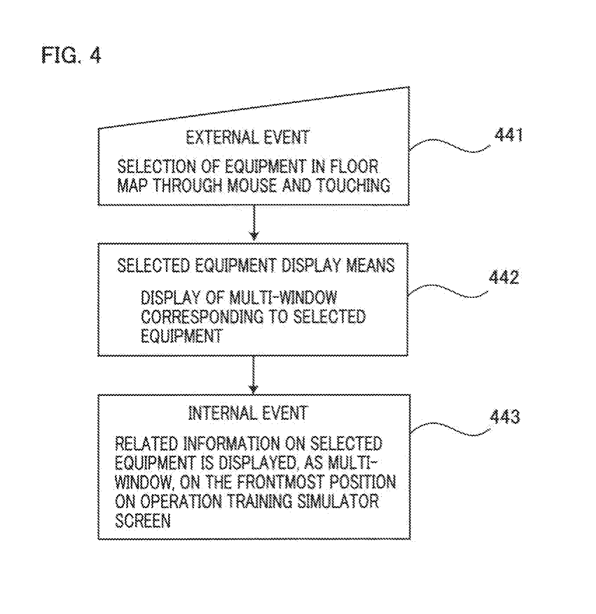

Next, there will be explained below the operation, on the screen of the operation training simulator, that corresponds to the operation by the maintenance man. FIG. 4 is a flowchart representing the procedure for displaying, on top of the other windows, a multi-window in which related information on selected equipment is displayed, in the operation training simulator according to Embodiment 1 of the present invention. In FIG. 4, in the step 441, when the maintenance man matches the cursor with the equipment as the hardware apparatus such as the controller or the computer and the maintenance tool in the floor-map image 20 and selects the equipment through touching or by use of the mouse, an external event 441 occurs. In the case where two equipment units are concurrently selected, only one operation training window that displays one of the two equipment units is displayed.

In the step 442, a selected equipment display means pops up the operation training window corresponding to the equipment such as a hardware apparatus or a maintenance tool, selected by use of the mouse or through touching. In the case where the selected equipment has already been displayed in the operation training window, no pop-up is implemented.

In the step 443, there occurs an internal event in which an operation training window to be selected and popped up or an operation training window that has already been displayed is displayed on top of the other windows on the display apparatus 1. Through the above-mentioned procedure, an operation training window selected by use of the mouse or through touching is displayed on top of the other windows on the display apparatus 1 of the operation training simulator in FIG. 1.

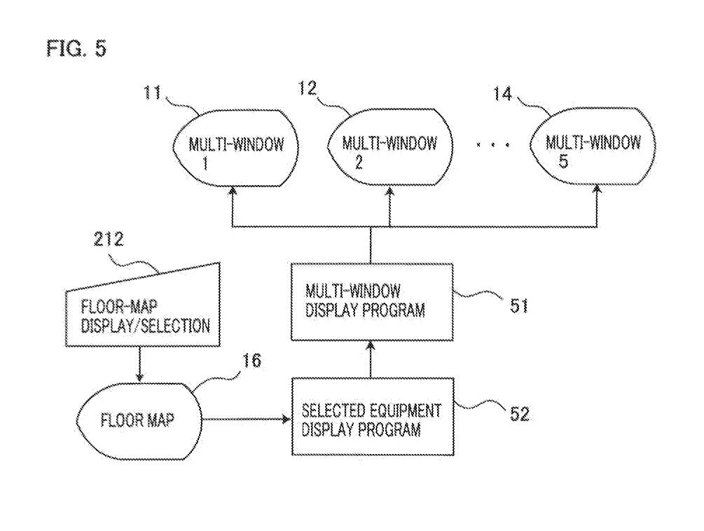

Next, there will be explained a method of displaying a multi-window at a time when the maintenance man selects equipment in the floor-map image 20 on the floor-map display window 201. FIG. 5 is a functional configuration diagram representing the way of associating a floor map with selection of an operation training window in the operation training simulator according to Embodiment 1 of the present invention. In FIG. 5, in a floor-map display selection function 213, there occurs an external event in which by use of the mouse or through touching, the maintenance man selects equipment such as a hardware apparatus or a maintenance tool in the floor-map image displayed in the floor-map display window 201. The occurrence of the external event activates a program 552 for determining which equipment in the floor map has been selected by the maintenance man, so that the equipment in the floor-map image, operated by the maintenance man, is determined.

Next, in order to display the operation training window corresponding to the equipment—it has been determined that the maintenance man selected this equipment, a multi-window display program 51 starts and displays only the operation training window corresponding to the selected equipment, for example, only the first operation training window 401 in a pop-up manner. The multi-window display program 51 can also determine whether the operation training window corresponding to the selected equipment has already been displayed in a pop-up manner; in the case where the operation training window has already been displayed, the multi-window display program 51 operates in such a way as to display the operation training window on top of the other windows on the display apparatus 1, based on the step 443 in foregoing FIG. 4.

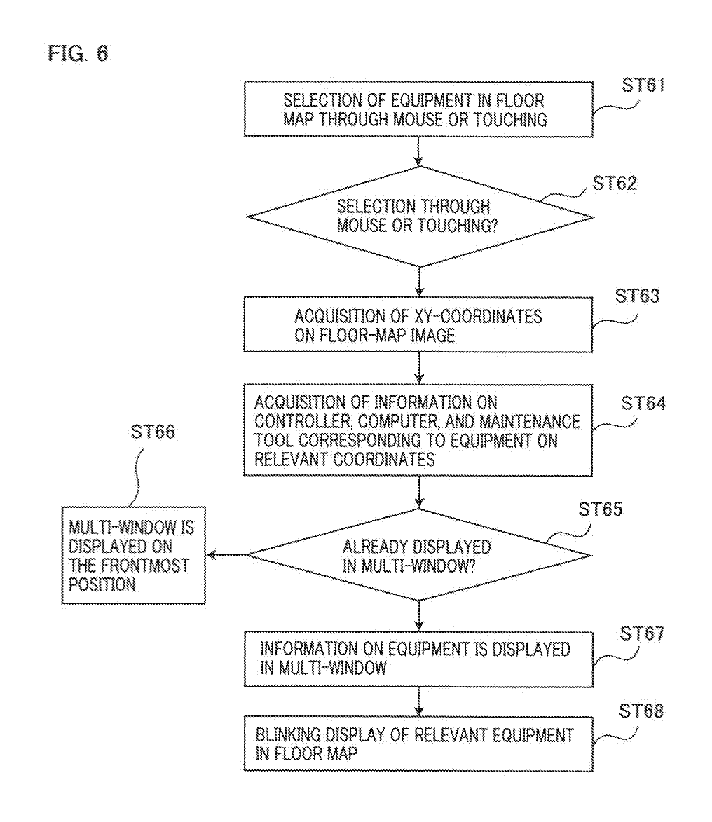

FIG. 6 is a flowchart representing the procedure of image-display operation in the operation training simulator according to Embodiment 1 of the present invention. In FIG. 6, when in the step ST61, the maintenance man selects equipment in the floor-map display window 201 by use of the mouse or through touching, it is determined in the step ST62 whether the selection has been implemented by use of the mouse or through touching, based on the program explained in FIG. 3; next, in the step ST63, the XY coordinates in the floor-map image are obtained; then, in the step ST64, information on equipment corresponding to the equipment on these coordinates is obtained. Next, in the step ST65, based on the foregoing obtained information on the equipment, a selected equipment display program 52 in FIG. 5 determines whether or not the operation training window corresponding to the obtained equipment has already been displayed.

In the case where the result of the determination in the step ST65 indicates that the operation training window corresponding to the floor map selected by the maintenance map in the step ST61 has already been displayed on the display apparatus 1 of the operation training simulator, the step ST65 is followed by the step ST66, where in the foregoing step 443 in FIG. 4, the selected operation training window is displayed on top of the other windows on the display apparatus 1.

In contrast, in the case where the result of the determination in the step ST65 indicates that the operation training window corresponding to the floor map selected by the maintenance map in the step ST61 has not been displayed on the display apparatus 1 of the operation training simulator, the step ST65 is followed by the step ST67, where the operation training window is displayed by the multi-window display program 51 and the selected equipment display program 52 in foregoing FIG. 5; in the step ST68 following the step ST67, a selected equipment blinking-display program 103 in foregoing FIG. 3 blinking-displays the equipment that has been selected by the maintenance man from the floor-map image in the step ST61.

The nuclear-plant operation training simulator according to Embodiment 1 of the present invention makes it possible to decrease the number of the display apparatuses to one, i.e., the minimum number, and makes it possible to display a multi-window image including not only the monitoring operation image but also maintenance tool images for the controller and/or the computer and a multi-window image including hardware and/or software of the controller and/or the computer, which are maintenance subjects, and hence makes it possible to facilitate switching operation.

### Embodiment 2

Next, a nuclear-plant operation training simulator according to Embodiment 2 of the present invention will be explained. In the operation training simulator according to foregoing Embodiment 1, when two or more operation training windows are displayed on the display apparatus of the operation training simulator, the screen may be complicated; therefore, in the operation training simulator according to Embodiment 2 of the present invention, a configuration for aligning operation training simulators to be displayed in a multi-window manner is provided so that confusion in an operator and a maintenance man is eliminated.

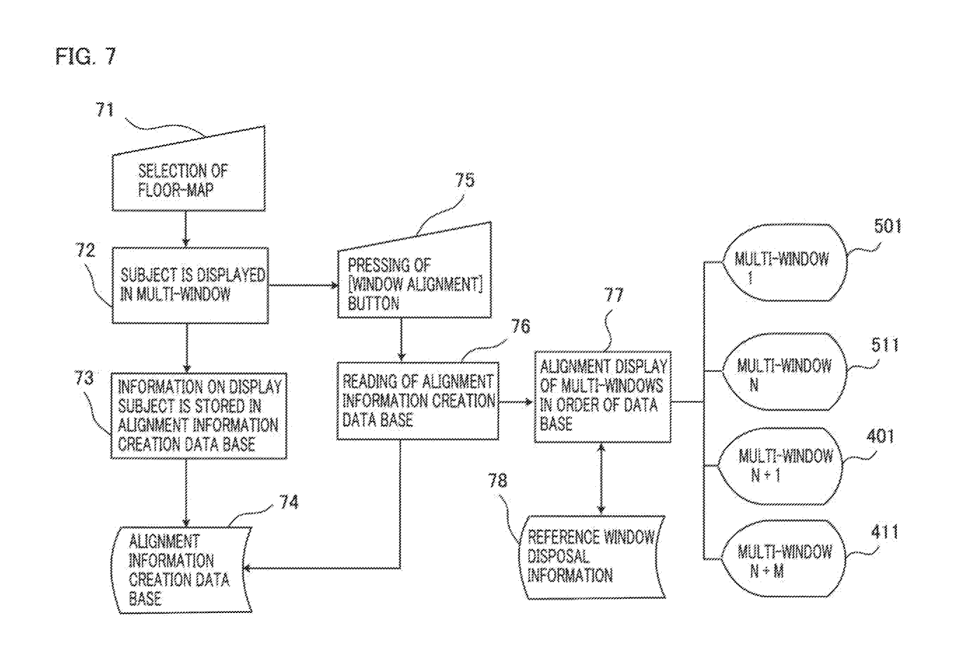

FIG. 7 is a functional configuration diagram representing a multi-window alignment display function in the operation training simulator according to Embodiment 2 of the present invention. In FIG. 7, when there occurs an event in which a function 71 selects a floor map, a function 72 displays the selected subject equipment in a multi-window; accordingly, then, a program 73 for storing information, which becomes a key for arbitrary alignment information, in a data base accumulates information on the display subject, as alignment information, in an alignment information creation data base 74.

Then, when following the function 72 for displaying subject equipment in a multi-window, there occurs an event in which a function 75 presses down the window alignment button, an alignment information creation data base reading program 76 reads the alignment information creation data base 74; based on the information accumulated in the data base, a program 77 for displaying the multi-window images in an aligned manner aligns the multi-window images, for example, in order of an apparatus abbreviation or in order of a display, and displays the multi-window images in an aligned manner on the display apparatus of the operation training simulator. When the multi-window on the display monitor is closed, the memory in the alignment information creation data base 74, that corresponds to the multi-window is released.

In the case where only one operation training window is displayed on the display apparatus 1, the alignment of the multi-window images is not implemented even when there occurs the event in which the function 75 in FIG. 7 presses down the window alignment button.

When the program 77, in FIG. 7, for displaying multi-window images in an aligned manner sets information 78 specifying a window disposal place as the reference of windows, the program 77 for displaying multi-window images in an aligned manner reads the information 78 and sequentially aligns windows as the specified arrangement.

The other configurations are the same as those in Embodiment 1.

### Embodiment 3

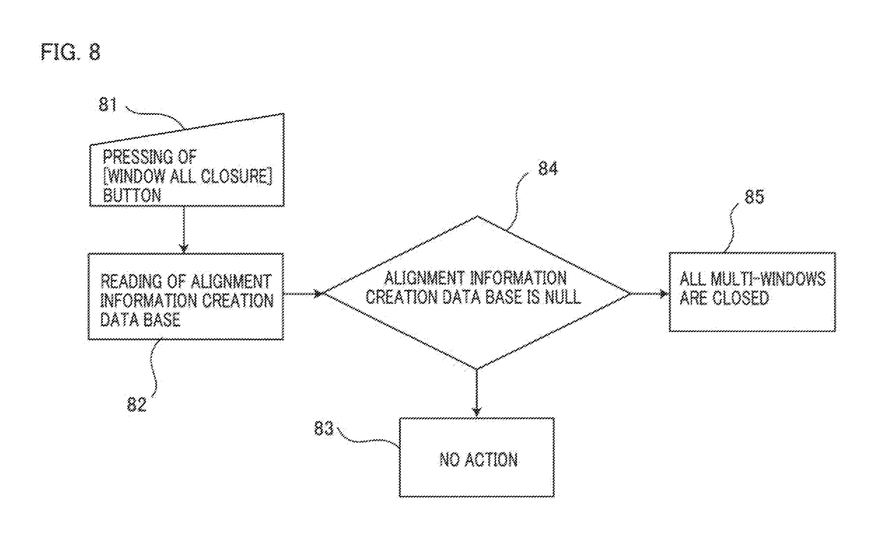

Next, a nuclear-plant operation training simulator according to Embodiment 3 of the present invention will be explained. FIG. 8 is a functional configuration diagram representing a multi-window all closure function in an operation training simulator according to Embodiment 3 of the present invention. In foregoing Embodiment 2, the alignment of multi-window images has been described; however, in Embodiment 3 represented in FIG. 8, a window all closure function is provided, i.e., there is provided a function in which when two or more operation training windows are displayed in a multi-window manner and hence the display screen is crowded, the multi-window images that have been displayed are collectively closed.

In FIG. 8, when there occurs an event in which a function 81 presses down a “window all closure button” in a floor map, a program 82 for reading the alignment information creation data base 74 represented in foregoing FIG. 7 starts and checks stored information in the alignment information creation data base 74; then, a determination function 84 determines whether or not the alignment information creation data base is NULL. In the case where the result of determination by the determination function 84 indicates that the alignment information creation data base is NULL, a function 83 does not do anything; however, in the case where the alignment information creation data base is not NULL, a program 85 for closing all multi-window images closes all the windows.

The other configurations and the operation are the same as those in Embodiment 2.

### Embodiment 4

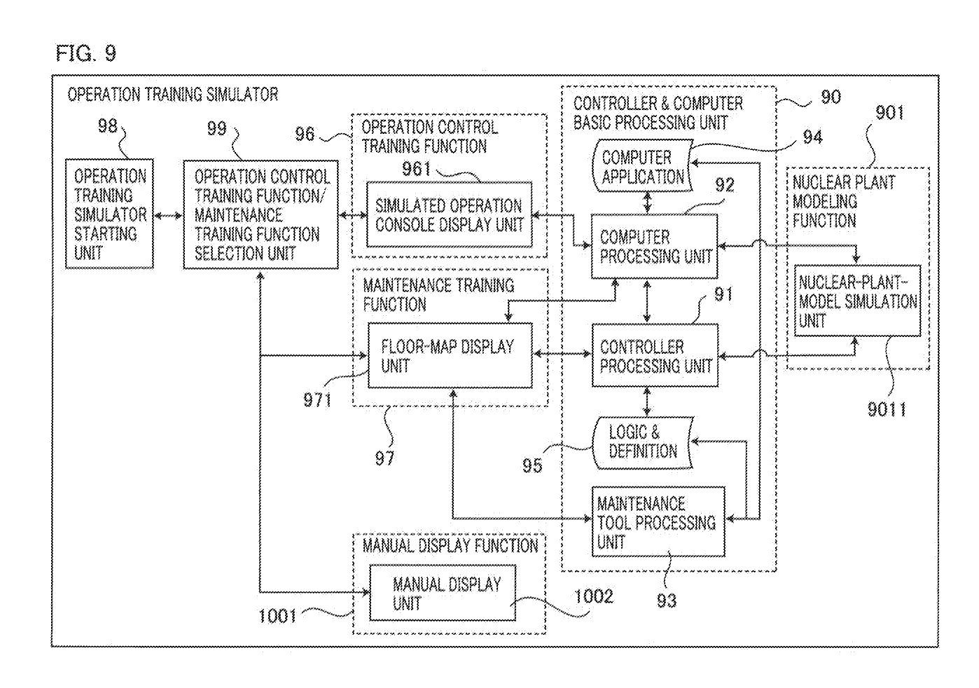

Next, a nuclear-plant operation training simulator according to Embodiment 4 of the present invention will be explained. FIG. 9 is a functional configuration diagram representing the relationship between multi-window image display control and an operation training function, a maintenance training function, and the like in the operation training simulator according to Embodiment 4 of the present invention. In each of foregoing Embodiments 1 through 3, multi-window control related to maintenance training has been described; however, in Embodiment 4 represented in FIG. 9, as an overall operation training simulator, in collaboration with the operation control training function and the nuclear plant modeling function, it is made possible that there is developed, concurrently and by means of a multi-window, a function of displaying, for the operator, training for monitoring operation in the central control room of the nuclear plant, a function of displaying, for the maintenance man, hardware apparatuses such as the controller and the computer and maintenance tools for the hardware apparatuses such as the controller and the computer, and a function of displaying a manual in which a maintenance procedure and a plant-operation procedure are summarized.

In FIG. 9, a basic processing unit 90 as a basic processor including a controller processing unit 91 as a controller processor and a computer processing unit 92 as a computer processor exchanges information on the computer with a nuclear-plant-model simulation unit 9011 as a nuclear-plant-model simulator in a nuclear plant modeling function 901 so that the overall nuclear plant can be simulated. As a result, the functions of operation training simulator, required for training of an operator and a maintenance man, can be realized by a single display apparatus and a single personal computer and hence an economical apparatus can be realized. The basic processing unit 90 includes a maintenance tool processing unit 93 as a maintenance tool processor, a computer application 94, and a logic/definition 95.

The operation training simulator represented in FIG. 9 includes an operation control training function 96 having a simulated operation console display unit 961 as a simulated operation console display, a maintenance training function 97 having a floor-map display unit 971 as a floor-map display, a manual display function 1001 having a manual display unit 1002 as a manual display, an operation training simulator starting unit 98, and an operation control training function/maintenance training function selection unit 99, in addition to the foregoing basic processing unit 90.

When the maintenance man selects the operation control training function 96, the simulated operation console display unit 961 is started; then, the simulated operation console display unit 961 collaborates with the computer processing unit 92 and the controller processing unit 91 in the basic processing unit 90 so that each of them is displayed on the display apparatus in a multi-window manner.

When the maintenance man selects the maintenance training function 97, the floor-map display unit 971 is started and calls the controller processing unit 91, the computer processing unit 92, and the maintenance tool processing unit 93 in the basic processing unit 90, so that screen display of a maintenance tool, display of the external appearances of hardware apparatuses such as the controller and the computer, change of the computer application 94 and the logic/definition 95 can be implemented.

The manual display unit 1002 makes it possible to select a manual among manuals selected by use of the mouse or through touching operation, to start the manual display function 1001, to turn the pages of a manual, and to write characters.

It is made possible to concurrently start the operation control training function 96, the maintenance training function 97, and the manual display function 1001.

The present invention is not limited foregoing Embodiments 1 through 4; in the scope within the spirits of the present invention, the configurations of Embodiments 1 through 4 can appropriately be combined with one another, can partially be modified, or can partially be omitted.

### INDUSTRIAL APPLICABILITY

The present invention can be utilized not only in the field of a nuclear-plant operation training simulator but also in the field of a nuclear plant.

### DESCRIPTION OF REFERENCE NUMERALS

1: display apparatus
20: floor-map image
40, 41: hardware apparatus image
50, 51: maintenance tool image
201: floor-map display window
401: first operation training window
411: second operation training window
501: third operation training window
511: fourth operation training window
60: switching button
70: window alignment button
212: floor-map starting unit
211: floor-map display program
213: selection-part detail display program
223: nuclear-plant-model simulation unit
224: controller simulation function unit
225: maintenance tool simulation function unit

1. A nuclear-plant operation training simulator that makes it possible to perform operation training for a nuclear plant on a screen of a single display apparatus, the nuclear-plant operation training simulator comprising:
a nuclear plant modeling function, including a nuclear-plant-model simulator, that calculates the state of the nuclear plant;
a basic processor that includes a controller processor, a computer processor, and a maintenance tool processor, and that exchanges information on a computer with the nuclear-plant-model simulator so that the overall nuclear plant can be simulated;
an operation control training function, including a simulated operation console display, that collaborates with the nuclear plant modeling function through the computer processor and performs operation control training for the nuclear plant;
a maintenance training function, including a floor-map display for displaying a floor-map image of the nuclear plant, that collaborates with the controller processor, the computer processor, and the maintenance tool processor and performs maintenance training for a hardware apparatus that controls the nuclear plant; and
a manual display function, including a manual display, that displays a manual for the operation control training and a manual for the maintenance training,
wherein the operation control training function, the maintenance training function, and the manual display function can concurrently be started and developed on the screen of the display apparatus,
wherein the display apparatus can display in a multi-window manner at least one of a floor-map display window that displays through the floor-map display the floor-map image corresponding to a floor on which a hardware apparatus for controlling the nuclear plant and a maintenance tool for maintaining the hardware apparatus are arranged, a window that displays a hardware apparatus image corresponding to the hardware apparatus, based on collaboration with the basic processor and the maintenance training function, and a window that displays a maintenance tool image corresponding to the maintenance tool, based on collaboration with the basic processor and the maintenance training function, and
wherein the window that displays the hardware apparatus image is displayed on the display apparatus when the hardware apparatus that is a subject of maintenance is selected in the floor-map image,
wherein the window that displays the maintenance tool image is displayed on the display apparatus when the maintenance tool to be utilized for the maintenance is selected in the floor-map image, and
wherein at least one of training for performing operation control of the nuclear plant through the simulated operation console display and training for performing maintenance of the hardware apparatus can be implemented by use of at least one of the window, displayed on the display apparatus, that displays a hardware apparatus image corresponding to the hardware apparatus and the window that displays a maintenance tool image corresponding to the maintenance tool.

2. The nuclear-plant operation training simulator according to claim 1, wherein at least one of the training for performing operation control of the nuclear plant and the training for performing maintenance of the hardware apparatus can be selected and implemented.

3. The nuclear-plant operation training simulator according to claim 1, wherein the display apparatus can display which one of the training for performing operation control of the nuclear plant and the training for performing maintenance of the hardware apparatus is being implemented.

4. The nuclear-plant operation training simulator according to claim 1, wherein when the training is being implemented by use of the hardware apparatus image or the maintenance tool image, a portion, of a floor-map image displayed in the floor-map display window, that corresponds to the hardware apparatus or the maintenance tool on which the training is being implemented is indicated.

5. The nuclear-plant operation training simulator according to claim 1, wherein when the hardware apparatus or the maintenance tool displayed in the floor-map image is selected, a window that displays an image corresponding to the selected hardware apparatus or the selected maintenance tool is displayed on top of the other windows on the display apparatus.

6. The nuclear-plant operation training simulator according to claim 1, wherein the display apparatus can display in a multi-window manner a window for displaying an image for indicating a plant operation procedure for the nuclear plant and a window for displaying an image for indicating a maintenance operation procedure.

7. The nuclear-plant operation training simulator according to claim 1, wherein the two or more windows displayed in a multi-window manner can be displayed at arbitrary positions on the display apparatus.

8. The nuclear-plant operation training simulator according to claim 1, wherein the two or more windows displayed in a multi-window manner can be aligned in predetermined order on the display apparatus.

9. The nuclear-plant operation training simulator according to claim 8, wherein the alignment can collectively be implemented by operating images displayed on the display apparatus.

10. The nuclear-plant operation training simulator according to claim 1, wherein the two or more windows displayed in a multi-window manner can collectively be closed.

11. The nuclear-plant operation training simulator according to claim 10, wherein the two or more windows displayed in a multi-window manner can collectively be closed by operating an image displayed on the display apparatus.

12. The nuclear-plant operation training simulator according to claim 2, wherein the display apparatus can display which one of the training for performing operation control of the nuclear plant and the training for performing maintenance of the hardware apparatus is being implemented.

13. The nuclear-plant operation training simulator according to claim 2, wherein when the training is being implemented by use of the hardware apparatus image or the maintenance tool image, a portion, of a floor-map image displayed in the floor-map display window, that corresponds to the hardware apparatus or the maintenance tool on which the training is being implemented is indicated.

14. The nuclear-plant operation training simulator according to claim 2, wherein when the hardware apparatus or the maintenance tool displayed in the floor-map image is selected, a window that displays an image corresponding to the selected hardware apparatus or the selected maintenance tool is displayed on top of the other windows on the display apparatus.

15. The nuclear-plant operation training simulator according to claim 2, wherein the display apparatus can display in a multi-window manner a window for displaying an image for indicating a plant operation procedure for the nuclear plant and a window for displaying an image for indicating a maintenance operation procedure.

16. The nuclear-plant operation training simulator according to claim 2, wherein the two or more windows displayed in a multi-window manner can be displayed at arbitrary positions on the display apparatus.

17. The nuclear-plant operation training simulator according to claim 2, wherein the two or more windows displayed in a multi-window manner can be aligned in predetermined order on the display apparatus.

18. The nuclear-plant operation training simulator according to claim 2, wherein the two or more windows displayed in a multi-window manner can collectively be closed.
